(19) United States
(12) Patent Application Publication
(10) Pub. No.: US 2013/0238482 A1
(43) Pub. Date: Sep. 12, 2013

(54) MARKET FOR FIXED INCOME ASSETS AND OVER-THE-COUNTER DERIVATIVES

(71) Applicants: James W. Toffey, Summit, NJ (US); Frank DiMarco, Pleasantville, NY (US)

(72) Inventors: James W. Toffey, Summit, NJ (US); Frank DiMarco, Pleasantville, NY (US)

(21) Appl. No.: 13/717,068

(22) Filed: Dec. 17, 2012

Related U.S. Application Data
(60) Provisional application No. 61/607,438, filed on Mar. 6, 2012.
(60) Provisional application No. 61/665,233, filed on Jun. 27, 2012.

(51) Int. Cl. G06Q 40/04

(52) U.S. Cl. CPC G06Q 40/04
USPC 705/37

(57) ABSTRACT

A computer-based method includes receiving a first indication from a first computer-based user interface terminal that a first party seeks a counterparty for a financial transaction involving a transfer of a first quantity of a fixed income asset or over-the-counter (OTC) derivative. receiving a second indication from a second computer-based user interface terminal that a second party seeks a counterparty for a financial transaction involving a transfer of a second quantity of the fixed income asset or OTC derivative, and locking the first party and the second party into a commitment to transfer ownership of the first quantity or the second quantity of the fixed income asset or OTC derivative at a first sales price that is not revealed to the first party or the second party prior to locking into the commitment.

### CROSS-REFERENCE TO RELATED APPLICATIONS

This application claims the benefit of U.S. Provisional Application Nos. 61/607,438, filed Mar. 6, 2012 and 61/665,233, filed Jun. 27, 2012, both entitled Mid-Market Crossing Market for Fixed Income Securities and a System for Selecting the Appropriate Trading Platform, the contents of which are incorporated by reference herein.

### BACKGROUND

This disclosure relates generally to fixed income assets, and more particularly to a system and method for the trading of fixed income assets and over the counter (OTC) derivatives.

Traditionally, traders and investors desiring to buy and sell securities have placed orders with brokers who traded on trading floors. When using a broker, traders accept the expense of using an intermediary and the information leakage inherent in approaching a third party.

### SUMMARY OF THE INVENTION

This specification describes technologies relating to providing a user access to systems and methods for transacting in fixed income assets and over the counter (OTC) derivatives.

In general, one innovative aspect of the subject matter described in this specification can be embodied in computer systems or computer-based methods that include the actions involved in facilitating a transfer of a fixed income asset or over the counter (OTC) derivative between parties. In a typical implementation, a computer-based processing system will receive indications from multiple sides of a marketplace, assign a value to the transaction, and generate an agreement between the parties to transact at the assigned value, where the parties agree to transact prior to knowing the assigned value.

More particularly, in one aspect, a computer-based method includes receiving a first indication from a first computer-based user interface terminal that a first party seeks a counterparty for a financial transaction involving a transfer of a first quantity of a fixed income asset or over-the-counter (OTC) derivative. In addition, the computer-based method includes receiving a second indication from a second computer-based user interface terminal that a second party seeks a counterparty for a financial transaction involving a transfer of a second quantity of the fixed income asset or OTC derivative. Moreover, the computer-based method includes locking the first party and the second party into a commitment to transfer ownership of the first quantity or the second quantity of the fixed income asset or OTC derivative at a first sales price that is not revealed to the first party or the second party prior to locking into the commitment.

The locking can occur by virtue of actions taken by a computer-based processor. In general, the parties can become locked into the commitment by virtue of the computer-based processor initiating one or more steps that will result in the transfer of ownership without either party having the option of backing out of the commitment before the transfer has been completed.

In a typical implementation, a value (i.e., the first sales price) will have been estimated using an algorithm with input data associated with one or more financial market observations involving assets or liabilities which may (or may not) include the security whose value has been estimated. The value may be calculated at a randomized time during a predefined window of time after the parties have become locked into the commitment.

In another aspect, a computer based method wherein the first sales price is calculated after receiving the first indication and the second indication, and may be based on a set of information that does not include any information received from the first party or the second party in connection with the indications received from them. The set of information may include many items, including swaption volatility, transactions involving fixed income securities reported by members of the Financial Industry Regulatory Authority under the Trade Reporting and Compliance Engine program, transactions on Swap Exchange Facilities, information from Swap Data Repositories, treasury prices, correlated bank credit default swaps, supply and demand technical, financial market observations, bonds that are comparable to the fixed income asset or OTC derivative, and equities.

In a typical implementation, the first sales price may be generated by propagating influences of market data represented by the information across multiple models of the marketplace.

In another aspect, the first sales price may be calculated based on information submitted as part of the indication. The first sales price may be, for example, a midpoint between the proposed prices received in connection with the indications.

In another aspect, the computer based method triggers a sequence of events leading to the transfer of the fixed income asset or OTC derivative from a first party to a second party. This may be by transferring the fixed income asset, or it may be by submitting instructions to a clearing entity for completing the transaction.

In yet another aspect, the parties are locked into the commitment at a time determined based on a computer based timer. In other aspects, the parties are locked in as soon as parties have submitted indications on opposite sides of a marketplace for an identical fixed income asset or OTC derivative.

In another aspect, the computer based method accepts indications and performs transactions where the first quantity is different than the second quantity of the fixed income asset or OTC derivative, such that one party is left with a remainder or is left with an unfilled or partially filled order. The computer based method may then accept an indication from a third party at a third computer based user interface terminal to obtain the remainder portion, or to provide fixed income assets to fill an unfilled or partially filled order. Prior to completing a transaction with the third party, the first or second party having the remainder or unfilled or partially filled order may be provided with an opportunity to retain ownership or submit a request for quote to an independent system.

Other embodiments of systems and methods of the invention include corresponding systems, apparatus, and computer programs, configured to perform the actions of the methods, encoded on computer storage devices, including non-transitory computer-readable media. These and other embodiments can each optionally include one or more of the features and any combination thereof as specified in the claims at the end of this specification.

In some implementations, the computer-based method includes calculating, with a computer-based processor, the first sales price for the fixed income asset or OTC derivative. The first sales price for the fixed income asset or OTC derivative may be calculated after receiving the first indication and the second indication. Moreover, the first sales price may be calculated based on information stored in a computer-based memory storage that does not include any information received in connection with the first indication or the second indication.

According to some embodiments, the information stored in the computer-based memory storage, upon which the first sales price is based, includes data related to one or more of: swaption volatility; transactions involving fixed income securities reported by members of the Financial Industry Regulatory Authority under the Trade Reporting and Compliance Engine program; transactions on Swap Exchange Facilities; information from Swap Data Repositories; treasury prices; correlated bank credit default swaps; supply and demand technicals; financial market observations; bonds that are comparable to the fixed income asset or OTC derivative; and equities.

Moreover, according to some embodiments, the information stored in the computer-based memory storage, upon which the first sales price is calculated, includes the data related to: the trades in fixed income securities or OTC derivatives reported by members of the Financial Industry Regulatory Authority under the Trade Reporting And Compliance Engine (TRACE) program or Swap Exchange Facilities (SEF) or Swap Data Repositories (SDR), the treasury prices, the market observations and the comparable bonds.

In certain implementations, the first sales price is generated by propagating influences of market data represented by the information across multiple models of the marketplace.

Moreover, in certain implementations, the first sales price is calculated as either a midpoint or an approximate midpoint between a first proposed price received in connection with the first indication and a second proposed price received in connection with the second indication.

According to some embodiments, the first sales price is calculated at a random point during a predefined window of time that begins when the first party and the second party become locked into the commitment.

In some implementations, the computer-based method includes, after locking the first party and the second party into the commitment, triggering a sequence of events that leads to the transfer of ownership of the first quantity or the second quantity of the fixed income asset or OTC derivative between the first party and the second party at the first sales price. Additionally, some implementations of the computer-based method include transferring ownership of the first quantity or the second quantity of the fixed income asset or OTC derivative between the first party and the second party.

Triggering the sequence of events, in certain embodiments, includes electronically-transmitting instructions to a fifth party to transfer the quantity of the fixed income asset or OTC derivative between the first party and the second party at the first sales price.

According to some implementations, locking the first party and the second party into the commitment occurs at a predetermined crossing time, which may be determined based at least in part on a computer-based timer, after receiving the first indication and the second indication. According to some implementations, locking the first party and the second party into the commitment occurs after receiving the latter of the first indication and the second indication, without waiting for a predetermined crossing time.

The first quantity of the fixed income asset or OTC derivative can be different than the second quantity of the fixed income asset or OTC derivative such that, after locking the first party and the second party into the commitment, the transfer of ownership leaves a remainder portion with either the first party or the second party that is not transferred as part of the transfer of ownership.

Some implementations of the computer-based method include receiving a third indication from a third computer-based user interface terminal that a third party seeks to obtain a remainder portion, if any, from ownership transfers that occur between any parties involving the fixed income asset or OTC derivative. In at least some of those instances, the computer-based method includes locking the third party and the first party or the second party into a commitment to transfer ownership of the remainder portion of the fixed income asset or OTC derivative at the first sales price or at a second sales price that is not revealed to the first party, the second party or the third party prior to locking the third party and the first party or the second party into the commitment.

In some implementations, prior to locking the third party and the first party or the second party into the commitment, the method includes presenting the first party or the second party with an option to retain ownership of the remainder portion. The option may be exercised or declined. Some implementations include presenting an option at the first computer-based interface device, if the first party has the remainder portion, that enables the first party to request via the first computer-based interface device one or more quotations for the remainder portion from potential counterparties; and/or presenting an option at the second computer-based interface device, if the second party has the remainder portion, that enables the second party to request via the second computer-based interface device one or more quotations for the remainder portion from potential counterparties.

According to certain embodiments, locking the first party and the second party into the commitment occurs without first revealing an identity of the first party at the second computer-based user interface terminal and without first revealing an identity of the second party at the first computer-based user interface terminal.

According to some implementations, the computer-based method includes receiving an indication from a fourth computer-based interface terminal that a fourth party is willing to sell up to a fourth quantity of the fixed income security or OTC derivative to any party whose request is not satisfied by a transaction; and locking the fourth party and the first party or the second party into a commitment to transfer ownership of up to the fourth quantity of the fixed income security or OTC derivative from the fourth party to the first party or the second party at the first sales price or at a second sales price that is not revealed to the first party, the second party or the fourth party prior to locking the fourth party and the first party or the second party into the commitment.

In some implementations, prior to locking the fourth party and the first party or the second party into the commitment, the computer-based method includes enabling the first party or the second party to avoid being locked into the commitment with the fourth party.

Another aspect includes a computer system with a first computer-based user interface terminal, a second computer-based user interface terminal; and a computer-based crossing engine (processing system) coupled to the first and second computer-based user interface terminals over a computer network. The computer-based crossing engine includes a computer-based processor and computer-based memory and is configured to: receive a first indication from the first computer-based user interface terminal that a first party seeks a counterparty for a financial transaction involving a transfer of a first quantity of a fixed income asset or over-the-counter (OTC) derivative; receive a second indication from the second computer-based user interface terminal that a second party seeks a counterparty for a financial transaction involving a transfer of a second quantity of the fixed income asset or OTC derivative, and lock the first party and the second party into a commitment to transfer ownership of the first quantity or the second quantity of the fixed income asset or OTC derivative at a first sales price that is not revealed to the first party or the second party prior to locking into the commitment.

Yet another aspect includes a non-transitory, computer-readable medium that stores instructions executable by a processor to perform the steps comprising: receiving a first indication from a first computer-based user interface terminal that a first party seeks a counterparty for a financial transaction involving a transfer of a first quantity of a fixed income asset or over-the-counter (OTC) derivative; receiving a second indication from a second computer-based user interface terminal that a second party seeks a counterparty for a financial transaction involving a transfer of a second quantity of the fixed income asset or OTC derivative; and locking the first party and the second party into a commitment to transfer ownership of the first quantity or the second quantity of the fixed income asset or OTC derivative at a first sales price that is not revealed to the first party or the second party prior to locking into the commitment.

In general, unless otherwise indicated, the term asset or security, as used herein, should be construed broadly to include any kind of asset, security, liability, etc. that can be valued.

Particular embodiments of the subject matter described in this specification can be implemented so as to realize one or more of the following advantages.

For example, increased trading opportunities may be made available in connection with asset classes that have previously had relatively low liquidity (e.g., fixed income assets and OTC derivatives). Increased trading opportunities may result in improved liquidity, more accurate and fair pricing for transfers of ownership involving these assets.

In some implementations, one or more of the techniques disclosed herein may be performed by a remotely-located computer or computer system. The results can then be accessed, for example, through a display (e.g., web-based graphical user interface (GUI)). In those implementations, a user may select a security of interest and then select a particular icon or link, for example, to begin a transaction related to that particular security.

The details of one or more embodiments of the subject matter described in this specification are set forth in the accompanying drawings and the description below. Other features, aspects, and advantages of the subject matter will become apparent from the description, the drawings, and the numbered paragraphs near the end of this disclosure.

### BRIEF DESCRIPTION OF THE DRAWINGS

FIG. 1 is a schematic representation of an exemplary computer-based processing system that facilitates the exchange of fixed income assets or OTC derivatives.

FIG. 2 is a flowchart that represents a user's interactions with the computer-based processing system of FIG. 1 in an exemplary embodiment.

FIG. 3A is a flowchart illustrating an exemplary interaction between a user and the computer-based processing system of FIG. 1.

FIG. 3B is a flowchart illustrating a second exemplary interaction between a user and the computer-based processing system of FIG. 1.

FIG. 3C is a flowchart illustrating a third exemplary interaction between a user and the computer-based processing system of FIG. 1.

FIG. 3D is a flowchart illustrating a fourth exemplary interaction between a user and the computer-based processing system of FIG. 1.

FIG. 4 is a flowchart that represents a user's interactions with a third party liquidity provider using the computer system of FIG. 1 in an exemplary embodiment.

### DETAILED DESCRIPTION

This disclosure relates to a computer-based system that facilitates the exchange of fixed income assets or OTC derivatives, as well as various methods and systems for implementing such an exchange.

Traditionally, traders and investors desiring to buy and sell securities have placed orders with brokers who traded on trading floors. When using a broker, traders accept the expense of using an intermediary and the information leakage inherent in approaching a third party. To combat these particular issues, traders and investors utilize several types of alternative trading systems (ATS), including crossing platforms. Crossing platforms are anonymous matching systems, matching buy and sell orders based on some algorithm. Since the systems are blind, information leakage is minimized, and since the systems are automated with little intermediary involvement, costs are significantly lower than placing orders with traditional brokers.

In traditional crossing markets, the marketplace aims to satisfy as many orders as possible by generating some optimal set of transactions based on some criterion (such as size, price, and/or prioritized traders). In doing so, a crossing valuation is often either defined by user inputs or by some direct measure of market value. In some crossing networks, the market itself determines whether orders will cross, and at what price those orders will be filled. In some markets, such as Pipeline, price thresholds can be pegged to reference points, and orders are filled only if someone offers to transact beyond a threshold defined by the reference points.

In the Liquidnet crossing market, for example, users of the H2O system can pin orders to the National Best Bid Offer (NBBO) mid-point. Those orders are used to execute overflow orders that did not find natural matches through a more direct Indication of Interest (IOI) interface. H2O, the system handling the pinned resting orders, cannot be designated as a preference by buy side customers. Although the NBBO is a floating price point, it floats with the market and is not a price independent of the market. Other systems, such as ITG's Posit also use the midpoint of the NBBO to cross.

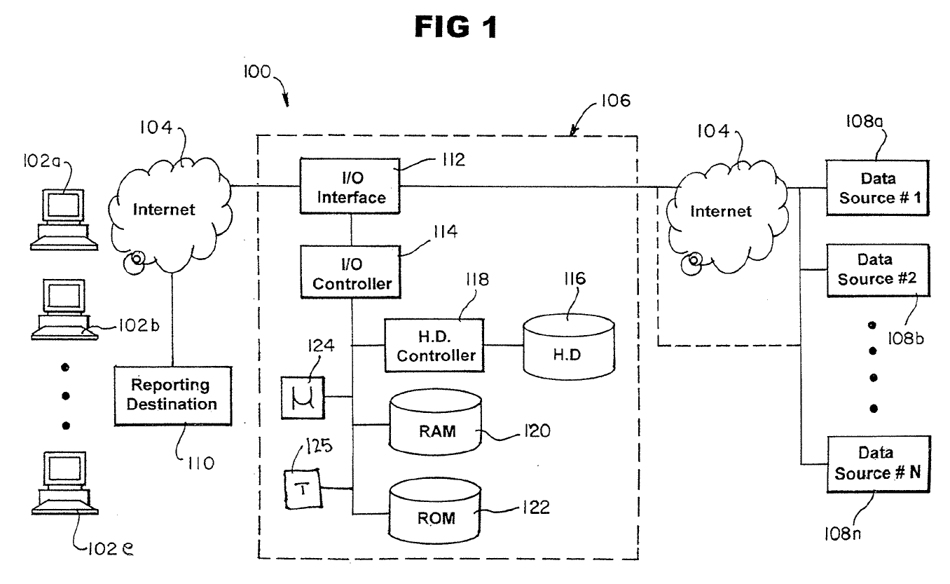

In various implementations, the computer system of FIG. 1 facilitates the transfer of a fixed income assets or OTC derivative between parties by, inter alia: (1) receiving a first indication from a first computer-based user interface terminal that a first party seeks a counterparty for a financial transaction involving a transfer of fixed income assets or OTC derivatives; (2) receiving a second indication from a second computer-based user interface terminal that a second party seeks a counterparty for a financial transaction involving a transfer of the same fixed income asset or OTC derivative; and (3) locking the parties into a commitment to transfer ownership of some quantity of the fixed income asset or OTC derivative at a price that is not revealed to either party prior to locking the parties into a commitment. In some embodiments, the computer-based processing system calculates the sales price for the commitment to transfer ownership.

In typical implementations, the multiple indications can be received during a predetermined time period leading up to a scheduled crossing time, such as in embodiments having a number of scheduled crossing times over the course of a day. In such embodiments, parties may be informed that the system will cross at a specified time, and users can plan their submission of indications accordingly. If a first sales price can be calculated at the crossing time that conforms to required parameters of the system, and the system has received a first indication from a first party and a second indication from a second party, the system will lock parties into agreements to transact.

In other embodiments, the indications may be processed at any time. In such embodiments, live orders may be shown in an order book format with at least one party willing to transact at an unknown price. In a typical implementation, the computer-based processor receives a first indication from a first party seeking a financial transaction involving a transfer of a fixed income asset or OTC derivative at any time, and that first indication is shown in an order book, for example, alongside other executable orders available only at fixed prices. In such an embodiment, the computer-based processor receives a second indication from a second computer-based user interface terminal that a second party seeks a counterparty for a transacting the fixed income asset or OTC derivative. In some implementations, the second party submits the second indication by selecting an asset from the order book. If a sales price can be calculated that conforms to required parameters of the system, a first sales price is assigned to a transaction and the first party and the second party are locked into an agreement to transact at the first sales price, wherein the parties are not informed of the sales price prior to being locked in to the agreement.

The computer-based processor assigns a first sales price to the asset (i.e., the fixed income asset or OTC derivative). The first sales price may be generated using one of several different techniques. In some embodiments, the processor may calculate or receive a projected price for the asset that is calculated based on information stored in a computer-based memory storage that does not include any information received in connection with the indications from the first party and the second party. In such embodiments, indications submitted may have no information beyond an identification of an asset and a quantity. In other embodiments, the processor may calculate or receive a first sales price based at least partially on some aspect of the indications received. In some embodiments, the indications submitted may further contain a price or indicia of value relative to some benchmark, so that a first indication can rest on an order book for an extended period of time without becoming stale. In some embodiments, the system may receive more than one indication that parties seek counterparties, and the processor may consider the indications individually or in aggregate.

In some embodiments, the computer-based processor locks the first and second party into a commitment to transfer ownership and transmits instructions to a third party for completing the transaction and/or for post trade processing. In some embodiments, a transaction may be completed based on the agreement without exiting the system implementing the method.

In some implementations, third parties (e.g., additional liquidity providers) other than the multiple parties from whom the processing system received indications may be available to transact for any remainder portion due to a quantity mismatch between the first indication and the second indication. More particularly, a remainder may be available if, for example, the first quantity of the fixed income asset or OTC derivative specified by the first party is different than the second quantity of the fixed income asset or OTC derivative specified by the second party such that, after locking the first party and the second party into the commitment, the transfer of ownership leaves a remainder portion with either the first party or the second party that is not transferred as part of the transfer of ownership.

In such an implementation, the third parties may agree in advance to transact for up to a specified quantity of the fixed income asset or OTC derivative. A third party may agree to buy a quantity remaining after a transaction between the first party and the second party is completed, or the third party may agree to sell up to a specified quantity where one of the parties seeks more of the asset than the other party is willing to transact. The third party may be a bank or market maker that has agreed in advance to transact consistently in certain situations, or it may be a party having a right of first refusal that has agreed to render a decision within a limited period of time.

The first or second party may interact with the third party by agreeing, in advance, to transact with the third party, where available, or a party having a remainder may be presented with an opportunity to transact with the third party immediately after completing a transaction with the first or second party. In some embodiments, the third party may be included in a crossing session to automatically fill orders and take remainders.

In addition to facilitating transactions of assets, the computer-based processor may further provide data related to the mid-market crossing market, such as estimations of available liquidity in various marketplaces and tools for assisting users in selecting the marketplace most suited to their needs.

This disclosure is not intended to be understood to be limiting in any sense, and is merely illustrative.

FIG. 1 is a schematic representation of an exemplary computer system 100 that can facilitate one or more of the techniques disclosed herein. As discussed in detail herein, in a typical implementation, the computer system 100 includes a plurality of user interface terminals 102a, 102b, 102c, 102d, and 102e for use by a first and second party for disseminating indications, a third and fourth party for providing liquidity, and/or a fifth party for clearing transactions, the user interface terminals coupled via a network (e.g., the Internet 104) to a processing system 106. In a typical implementation, the processing system 106 is configured to implement functionality associated with the crossing engine disclosed herein. There may be multiple users of each type accessing the processing system 106 at any given time. The processing system 106 is coupled (e.g., through the Internet 104) to a plurality of data sources 108a, 108b . . . 108n, which may provide, for example, records of trades in fixed income assets reported by members of the Financial Industry Regulatory Authority (FINRA) under the Trade Reporting and Compliance Engine (TRACE) program, data related to trades in municipal securities reported by the Municipal Securities Rulemaking Board (MSRB) under the Real-Time Transaction Reporting System (RTRS), data provided to centralized to centralized recordkeeping facilities, such as Swap Data Repositories (SDR) or any other data reporting paradigm. In some implementations, the data can also include data related to United States Treasury Securities and data related to assorted market observations other than transactions. In some implementations, the data sources include records of quotes for various assets.

In general, the processing system 106 is operable to receive data in electronic form from the plurality of data sources 108a, 108b . . . 108n, use that data to estimate corresponding valuations for one or more security and use the valuations to facilitate transactions between users at user interface terminals 102a-d.

In some implementations, the processing system 106 periodically receives new data that is relevant to calculating the sales price for a fixed income asset or OTC derivative, stores the new data in a database, and periodically updates a calculated sales price for the fixed income asset or OTC derivative based, at least in part, on the new data. Typically, the first assigned sales price is intended to represent a projected sales price for the asset at a first time for a first transaction, such as a transaction between a first user and a second user, and the recalculation is to generate a sales price to be used at a later time, such as in a transaction between the first user and a third party for a remainder of a transaction between the first user and the second user.

In some implementations, the user interface terminals 102a-d used for transacting with each other may be coupled to one or more user interface terminal 102e for clearing transactions through the internet 104. After users at user interface terminals 102a-d are locked into a commitment to transfer ownership by processing system 106, the processor may send the commitment to a user interface terminal 102e for clearing and processing the order. In some embodiments, clearing of transactions may occur within the processing system 106 for implementing the method for facilitating the crossing of securities.

The illustrated processing system 106 includes an input-output interface 112 configured to receive and transmit data in electronic format from and to external system components. Examples of the data that may be received at the I/O interface 112 include data associated with one or more financial market observations from one or more of the data sources 108a, 108b . . . 108n and indications from one or more of the user interface terminal 102a-d. A controller 114 is provided for the I/O interface 112.

The illustrated processing system 106 includes a hard drive 116 and a hard drive controller 118. The hard drive 116 is generally operable to store executable computer programs that facilitate various aspects of the functionality disclosed herein.

The illustrated processing system 106 includes computer-based memory, including a random access memory (RAM) module 120 and a read-only memory (ROM) module 122. In a typical implementation, the RAM module 120 stores data to support various aspects of the functionality disclosed herein, where the stored data will generally need to be accessed very quickly in any random order. In a typical implementation, the ROM module 122 stores data (e.g., firmware, or the like) that is unlikely to need frequent updates.

The illustrated processing system 106 includes a processor 124. Although the processor 124 is schematically represented in FIG. 1 as a single box, the processor 124 may include one or more processing units that are at a single physical location (e.g., in the same computer housing) or distributed across various physical locations and in different housings, etc.

In a typical implementation, the processor 124 is configured to perform many of the functionalities, including algorithms, calculations, etc. attributed to the computer system 100 and to the processing system 106 throughout this disclosure. These functionalities include, for example, valuing assets based on the data associated with financial market observations received from the plurality of data sources 108a, 108b . . . 108n, valuing assets based on information included in indications submitted by users at user interface terminals 102a-d, routing indications between parties as appropriate, generating agreements between parties, etc.

The illustrated processing system also includes a computer-based timer 125. In a typical implementation, the computer-based timer 125 provides timing functionality that can be used to trigger various actions at certain times. For example, in some instances, the first party and the second party become locked into the commitment to transfer ownership and the locking occurs at a predetermined crossing time. In a typical implementation, the predetermined crossing time is determined, at least in part, by referring to the computer-based timer 125.

In the illustrated computer system 100, each user interface terminal 102a-e includes a visual display and a keyboard. In various implementations, one or more of the user interface terminals 102a-e differ from what is shown. For example, some may include additional or alternative components, such as an audio speaker, a printer, a computer mouse, etc. that facilitate the user's interactions with the computer system 100 functionality. User interface terminals 102a-e may be, for example, tablet computers, or smartphones, and data input may be through a touch screen or through some other command interface.

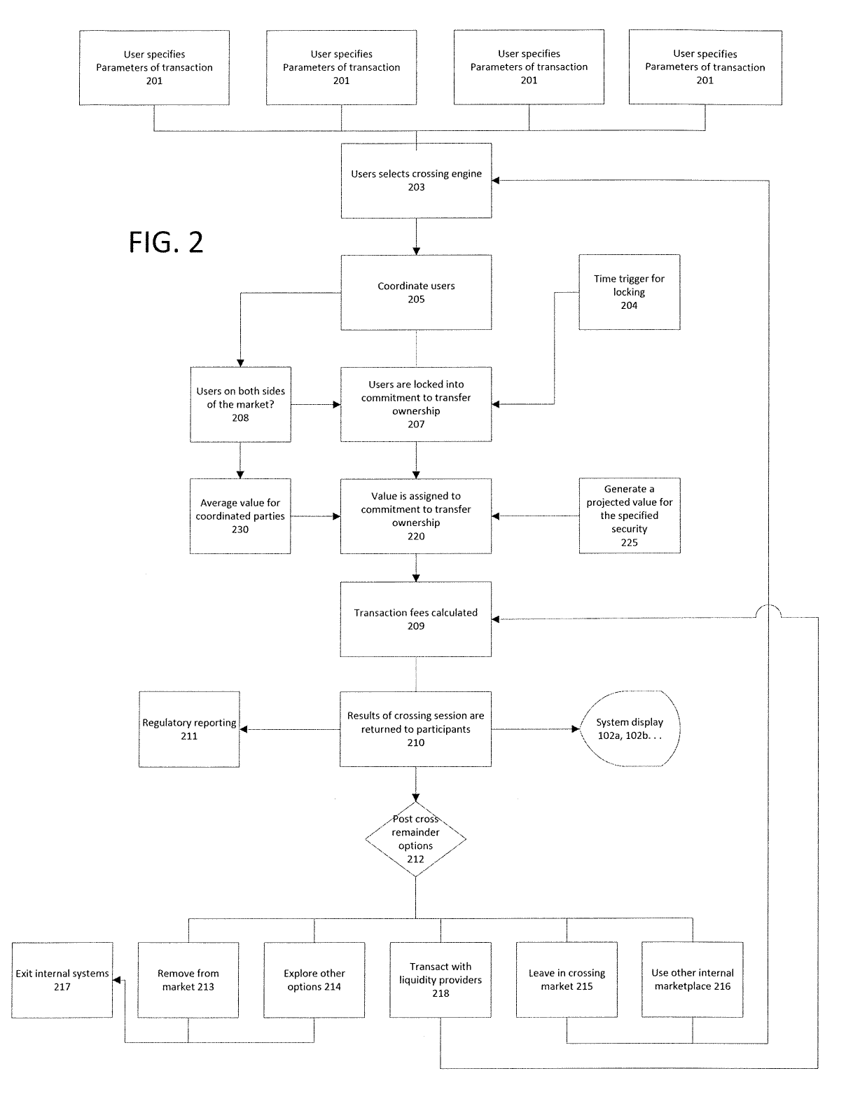

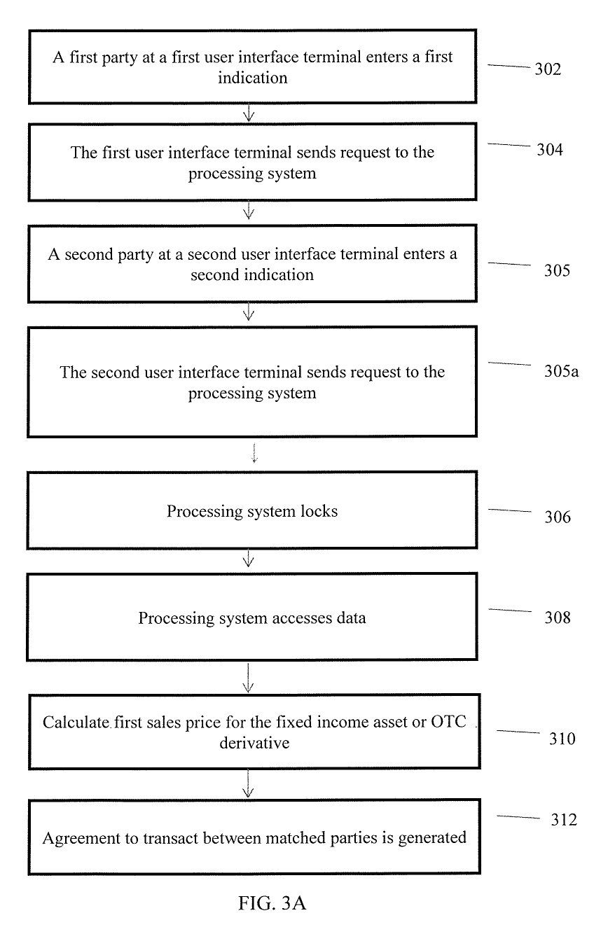

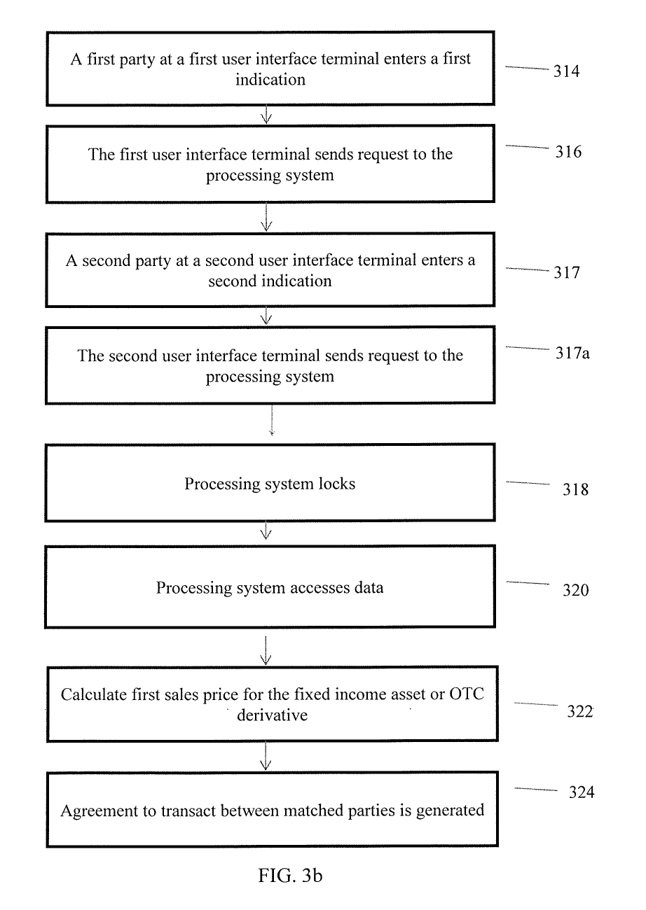

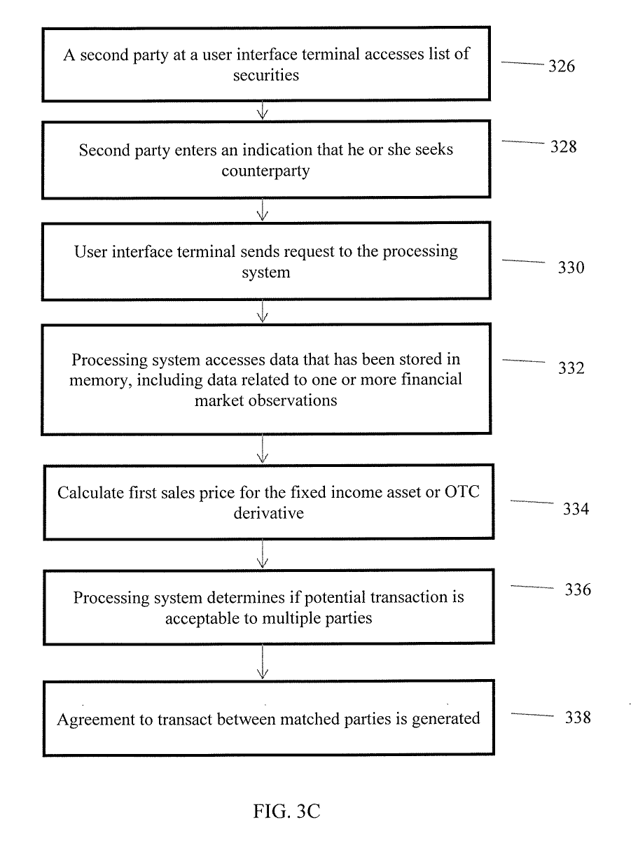

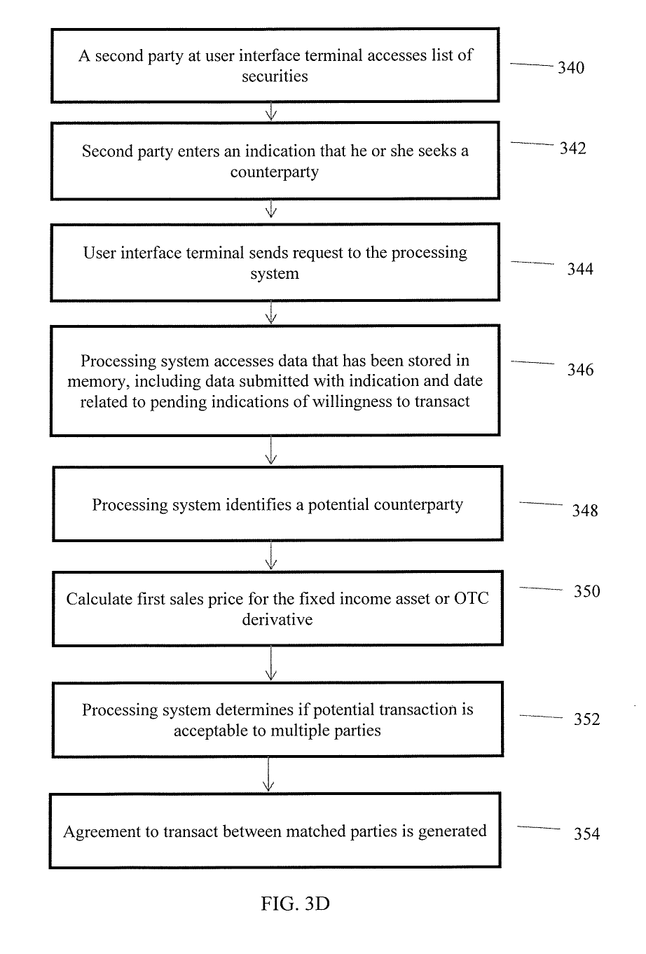

FIG. 2 shows an implementation of an exemplary method for facilitating the crossing of securities. In the illustrated embodiment, a number of users, including a first party and a second party, can provide, at user interface terminals 102a and 102b, indications that they seek to transact fixed income assets or OTC derivatives (201). The indications may be submitted by, for example, selecting a security from a list and entering a quantity at user interface terminal 102a or 102b, completing a form including the information required for the transaction, selecting a security from an order book showing executable orders, or entering an identifier for the security the party wishes to transact, among other possibilities. Once the first party selects a crossing market at 203, which is market in accordance with one of the embodiments of FIG. 3A-D, appropriate order details are submitted to the system. The selection of the marketplace (203) may be completed before indications are submitted (201), or may be implicit in a user's usage of the system 100. In some embodiments, the parameters of the marketplace may be governed by background options that apply to all interactions between the first party and the system 100. A second party may access the system 100 the same way, or may select the crossing engine in a different manner. In some embodiments, for example, the first party may enter a crossing system through use of an order book while having background options selected, and the second party may explicitly approach the marketplace as a crossing marketplace.

When multiple users engage a crossing engine, such as the execution of the methods of FIG. 3A-D on the processing system 106, the parties do so by submitting indications that they seek a counterparty for a financial transaction, and that they are willing to be locked into a commitment to transfer without first knowing the value. The processing system 106 receives at least one such indication from each of, for example, a buy side and a sell side, and coordinates potential transactions between multiple users. In the case of a single buy side indication and a single sell side indication, the processing system 106 pairs the parties so that they can be locked into a commitment to transact. If more than two parties have submitted indications (201), the processing system 106 coordinates (205) users so that transactions can occur between parties by finding matches for the first party and the second party based on the fixed income asset or OTC derivative they wish to transact. The processing system 106 may coordinate parties based on, for example, time priority or price based priority. The processing system 106 then locks users into a commitment to transfer ownership of assets from one user to another (207). In some embodiments, locking users into a commitment to transfer ownership immediately assigns a price to the commitment. In other embodiments, locking users into a commitment (207) forges an agreement between users to accept a price to be generated in the future.

In some embodiments, a time trigger is used (204) to select a time at which to lock users into a commitment to transfer ownerships. In other embodiments, the users are locked into a commitment as soon as a party's indication is coordinated (205) so that it has a match. In some examples, this happens when indications are submitted on each of two sides of the market (208).

In some implementations, after the users are locked into a commitment (207), a first sales price is assigned to the commitment (220). That price may be provided by calculating, with processing system 106, a first sales price for the fixed income asset or OTC derivative based on information stored in storage accessible to processing system 106 without taking into account any information received in connection with the indications from the first party or the second party (at 225). In some embodiments, the first party and the second party submit indications on two sides of a market for an asset, and the indications include a valuation of the asset indicated. In such an embodiment, the processing system may average the values submitted (230) and provide the average value to the system 100 for use as a first sales price. The value is then assigned to the commitment (220).

In some embodiments, the system 100 enables the first party or the second party to specify, as a parameter of the transaction, criteria that must be satisfied to generate an acceptable transaction. Such criteria may include a maximum or minimum valuation, or a maximum or minimum quantity to be transacted. In such an embodiment, when users are found on both a buy side and a sell side of the market (208) the users are first matched provisionally as potentially viable. The processing system 106 then generates a valuation or other parameter that would be assigned to a transaction, such as the average value of the match (230), or a quantity that can be transferred, and tests the potential transaction against all parameters, including the criteria assigned (201). System 100 then only locks users into a commitment (207) if all parameters, including the criteria are satisfied for the transaction to proceed as proposed.

In the illustrated embodiment, proposed transactions are coordinated (205) based on time priority or price priority. It will be understood that an alternative matching algorithms may be applied, and the various embodiments discussed herein may specify and apply alternative priorities.

After parties are locked into agreements, the processing system calculates transaction fees (209) and passes details of resulting agreements (210) to visual displays at user interface terminals 102a and 102b. In some embodiments, details of the agreements to which parties have been locked in may be handed off to clearing organizations for processing as well as internal and external reporting destinations (211).

In some embodiments, the details surrounding indications submitted (201), to processing system 106, such as quantity of a preferred transaction, may only be partially satisfied in a first attempt at matching users and generating agreements. In such a situation, a party may not have been locked into an agreement, or a party may have only been locked into an agreement for a portion of an intended transaction during the crossing process of FIGS. 3A-D. In such a scenario, the processing system 106 may present options to address a user's remaining portion in a partially matched order, or a remainder (212).

If a user is left with a remainder, the illustrated embodiment provides users with five options. The user may (1) remove the order from the market (213) and choose not to transact, (2) explore options outside of the system of the illustrated embodiment (214), (3) transact directly with designated liquidity providers (218), (4) leave the order active in the crossing marketplace initially selected (215), or (5) use an alternative marketplace internal to the system of the illustrated embodiment (216).

If the user chooses to remove the order from the market (213) or explore marketplaces other than those provided in the system of the illustrated embodiment (214), the user exits the internal systems of the embodiment (217). Alternatively, if the user chooses to leave the order active in the crossing market initially selected (215), the user's order is returned to the processing system 106 implementing the crossing process (203) of FIGS. 3A-D.

If the user indicates intent to transact directly with liquidity providers (218) by, for example, selecting a background option prior to a crossing session or by making an entry in a user interface indicating such intent; the user may complete his transaction with a designated liquidity provider. The liquidity provider may be a provider with an agreement with the manager of the method who has agreed to provide liquidity in specified situations. In some embodiments, the liquidity provider may be a party having a right of first refusal or other preferable terms in exchange for provision of some minimum amount of liquidity. In some embodiments, liquidity providers are selected based on their willingness to transact. For example, some set of parties may be ranked based on their frequency of transacting, and parties may receive an opportunity for first refusal in the order in which they are ranked. If the user indicates intent to complete his order through a liquidity provider (218), the order may be routed to a liquidity provider who will be given an opportunity to transact. In some embodiments, the step may include a sequence of liquidity providers getting rights to refuse an order. In some embodiments, a liquidity provider may have agreed in advance to complete a transaction.

If the liquidity provider completes a transaction with a user, the user is redirected to the fee calculation stage (209) for finalizing of the order. If, however, no liquidity provider completes the transaction, the user may be returned to selecting between post-cross remainder options 212.

In some embodiments, liquidity providers take the remainder of an order within a crossing session. A user may, for example, select an option to transact directly with liquidity providers. Where such an option is selected, an order is redirected to the liquidity provider immediately after failing to completely match.

Finally, if the user indicates an intent to explore other marketplaces in the system of the illustrated embodiment, the user is redirected to the selecting the preferred marketplace (at 203).

A crossing market selected by a user (at 203) may be of several types. FIGS. 3A-3D illustrate functionality associated with four different types of computer-implemented crossing marketplaces. Each figure illustrates an exemplary interaction between a user and the processing system 106.

FIG. 3A is a flowchart showing an exemplary interaction between users of the system 100 and the computer-based processing system 106 of FIG. 1 to facilitate a transaction involving the transfer of a fixed income asset or OTC derivative. According to FIG. 3A, a first party at a first user interface terminal enters a first indication (at 302) that he or she is seeking a counterparty for a financial transaction involving a transfer of a first quantity of a fixed income asset or OTC derivative. In a typical implementation, the first party accomplishes this by entering information into the first user interface terminal 102a identifying a particular fixed income asset or OTC derivative he or she is interested in having transferred, identifying the first quantity (i.e., the amount of the fixed income asset or OTC derivative) he or she is interested in having transferred, In one example, using a computer mouse, a keyboard, or some other computer-based input device, the first party may select one security from a plurality of listed securities. In another example, the first party may select a security by directly identifying it with a code such as a CUSIP (a classification assigned by the Committee on Uniform Security Identification Procedures). In some embodiments, the first party further indicates the side of a transaction the first user wishes to take, that is, whether the first party is interested in buying or selling the entered quantity of the identified fixed income asset or OTC derivative. In some embodiments, the first party also specifies a proposed price for the transfer. In some instances, if the first party specifies a proposed price for the transfer, the proposed price does not end up being the price that is applied to the transfer, if one occurs.

In a typical implementation, the first user interface terminal sends (at 304) the first party's indications to the processing system 106 for processing. In response, the processing system 106 typically includes the specified quantity of the specified fixed income asset or OTC derivative in a pool of securities to be potentially transacted (i.e., transferred between parties) at a specified time. This pool may be stored in an electronic database, for example, in random access memory (RAM) module 120.

According to the illustrated method, a second party at a second user interface terminal (e.g., 102b in FIG. 1) enters (at 305) a second indication that the second party seeks a counterparty for a financial transaction involving a second quantity of the fixed income asset or OTC derivative. In a typical implementation, the second party accomplishes this by entering information into the second user interface terminal 102b in much the same way that the first party entered information into the first user interface terminal 102a, discussed above. In some embodiments, the second party further indicates the side of a transaction he or she wishes to take, that is, whether the second party is interested in buying or selling the entered quantity of the identified fixed income asset or OTC derivative. In some embodiments, the second party also specifies a proposed price for the transfer. In some instances, if the second party specifies a proposed price for the transfer, the proposed price does not end up being the price that is applied to the transfer, if one occurs.

In a typical implementation, the second user interface terminal 102b sends (at 305a) the second party's indication to the processing system 106 for processing. In response, the processing system 106 typically includes the quantity of the fixed income security or OTC derivative specified by the second user in a pool of securities to be potentially transacted at a specified time. This pool may be stored in an electronic database, for example, in random access memory (RAM) module 120.

In the embodiment shown, the fixed income asset or OTC derivative transaction is either a buying action or a selling action, and the first party's indication is for one of buying or selling and the second party's indication is for the other of buying or selling. In addition, in the embodiment shown, both the first party and the second party indicate that they are seeking a counterparty for a financial transaction involving the same fixed income asset or OTC derivative. As discussed herein, the first quantity specified by the first party and the second quantity specified by the second party can be the same or different quantities.

Assuming that the indications from the first party and the second party are both directed to the same fixed income asset or OTC derivative, the processing system 106 identifies the first party and the second party as candidate trading partners. The identification of candidate trading partners (i.e., parties that have complimentary needs) can happen either before or after the processing system 106 locks the parties into an agreement. The system then locks (306) the first party and the second party into a commitment to transfer ownership of either the first quantity or the second quantity of the fixed income security or OTC derivative at a first sales price that is not revealed to the first party or the second party prior to locking into the commitment. The time of the system lock (306) may be known to the first party and the second party in advance. In a typical implementation, for example, the processing system 106 may be configured to implement a new lock between parties that qualify as potential trading partners, for example, once a day or several times a day. System locks may be more or less frequent for more or less liquid securities. In general, after a lock occurs, any information that the parties enter into the system will not be used or considered by the system for the immediately upcoming transfers.

In general, after the processing system 106 locks, the first party and the second party may no longer withdraw or edit their respective indications (i.e., either the first or second quantities or the identity of the corresponding fixed income asset or OTC derivative). Moreover, in general, the first and second parties become locked into the commitment by virtue of the processing system 106 initiating one or more steps that will result in the transfer of ownership without either the first party or the second party having the option of backing out of the commitment before the transfer has been completed.

After the system lock, the processing system 106 accesses (308) data that has been stored in memory (e.g., random access memory (RAM) module 120), including data that is related to one or more financial market observations. The data accessed can be used to calculate a first sales price (e.g., a valuation) for the fixed income asset or OTC derivative (310). In at least some implementations, the data does not include any information received in connection with the first indication or the second indication.

In some implementations, the data includes data related to one or more of swaption volatility, transactions involving fixed income securities reported by members of the Financial Industry Regulatory Authority under the Trade Reporting and Compliance Engine program, transactions on Swap Exchange Facilities, information from Swap Data Repositories, treasury prices, correlated bank credit default swaps, supply and demand technical, financial market observations and bonds that are comparable to the fixed income asset or OTC derivative, and equities. Moreover, in some implementations, the date includes data related to: the trades in fixed income securities or OTC derivatives reported by members of the Financial Industry Regulatory Authority under the Trade Reporting And Compliance Engine (TRACE) program or Swap Exchange Facilities (SEF) or Swap Data Repositories (SDR), the treasury prices, the market observations and the comparable bonds.

According to the illustrated method, the processing system 106 then calculates (e.g., with the computer-based processor 124) (at 310) a first sales price for the fixed income asset or OTC derivative. In a typical implementation, the first sales price is the price at which either the first quantity or the second quantity of the fixed income asset or OTC derivative will be transferred between the first party and the second party. Typically, the price is calculated sometime after the processing system 106 locks the parties into an agreement.

The first sales price can be calculated (i.e., the fixed income security or OTC can be valued) by using any one of a plurality of valuation techniques or algorithms. Moreover, the first sales price can be calculated by the processing system 106 in FIG. 1 or any other processor or computer-based processing system, or the data accessed by the processing system may be the valuation itself. In some implementations, the valuation technique or algorithm may be applied in real time, and a projected value (i.e., the calculated first sales price) is a current value as of the time that the processing system accesses the data (308). Alternatively, the valuation technique or algorithm may be applied to a set of data that is substantially current as long as the time period described by the data extends beyond the time of the system lock (306).

In one embodiment, for example, the processing system 106 calculates the first sales price by first accessing data that was previously stored in a database (e.g., RAM module 120). This data can include, for example, data related to a plurality of financial market observations. The financial market observations may involve observations directly related to the specified securities, observations involving assets closely related to the specified security, or other observations. Often, in the case of low liquidity assets, direct observations of the target asset are unavailable, and, in those cases, observations of related assets or other assets may be more relevant to valuation than if direct observations were available. In a typical implementation, the stored data will have been received from one or more of the data sources 108a, 108b . . . 108n and may have arrived at the processing system at different times.

In some implementations, a valuation is assigned (i.e., a first sales price is calculated) at a random time during a predefined window of time after the processing system 106 locks (306). The window of time may be, for example, the fifteen minutes immediately following the processing system 106 lock (306).

In various implementations, a value or valuation associated with the specified security is represented as a price, yield, or spread. The spread valuation represents, for example, the difference between the yield of two different investments. When evaluating a security in terms of spread, the second investment may be, for example, a credit risk-free benchmark security or a reference rate.

After the processing system calculates the first sales price (e.g., provides a valuation for the security) (310), the processing system 106 generates an agreement, or agreements, to transact for all parties, including the first party and the second party, matched by the system (312). The agreement to transact can be formed when a value is assigned to the commitment to transfer ownership that occurred at the system lock (306).

In some embodiments, more than two users or parties may submit indications (at 201). When more than two users or parties submit indications, the illustrated processing system 106 can match parties based, for example, on time priority. If an unequal quantity is identified on opposite sides of a transaction, the processing system 106 can match the earliest orders to be submitted first, and later submissions are more likely to be left with remainders after a cross. Alternatively, transactions may be matched based on size priority or some alternative selection process. The matching in the illustrated embodiment is anonymous, which means that the identity of the first party, for example, is not revealed by the processing system 106 to the second party.

Once the agreements to transact (312) are generated, the processing system 106 triggers a sequence of events that leads to the transfer of ownership of the first quantity or the second quantity of the fixed income asset or OTC derivative between the first party and the second party at the valuation. In some embodiments, the agreement to transact is submitted by the processing system 106 to a third party for clearing. In that example, the processing system 106 transmits electronic instructions to the third party at a third user interface terminal (e.g., 102e in FIG. 1) to clear the transaction (i.e., to transfer ownership of either the first quantity or the second quantity of the fixed income asset or OTC derivative between the first party and the second party at the first sales price). In other embodiments, processing system 106 may be configured to complete transactions and coordinate or complete the transfer of ownership of the fixed income asset or OTC derivative. The processing system 106 may then calculate transaction fees (209) and report transactions resulting from the cross to participants (210) at their respective user interface terminals, as well as complete any required third party reporting 211. For example, in some implementations, the processing system 106 transmits the clearing instructions to a third party at one of the user interface terminals (e.g., 102e).

FIG. 3B is a flowchart showing an exemplary interaction between users of the system and the computer-based processing system 106 of FIG. 1 to facilitate a transaction involving the transfer of a quantity of a fixed income asset or OTC derivative. The exemplary interaction in FIG. 3B is similar to the exemplary implementation in FIG. 3A, except in the exemplary interaction in FIG. 3B, the first user and the second user respectively enter a first proposed price and a second proposed price for the fixed income asset or OTC derivative.

Moreover, in the exemplary interaction of FIG. 3B, the processing system 106 generally takes these proposed prices into consideration in calculating the first sales price for the quantity of the fixed income asset or OTC derivative to be transferred. For example, in some implementations, the first sales price is calculated as a midpoint between the first proposed price received in connection with the first indication from the first party and a second proposed price received in connection with the second indication from the second party. In some implementations, the calculated first sales price will be an approximate midpoint between the first proposed price and the second proposed price. The calculated first sales price may be an approximate midpoint if, for example, there is no exact midpoint between the first proposed sales price and the second proposed sales price. So, if the first proposed sales price is $8.00 per unit and the second proposed sales price is $8.07 per unit, then the calculated first sales price may end up being, for example, an approximate midpoint (e.g., $8.03 or $8.04 per unit).

According to FIG. 3B, a first party at a first user interface terminal (e.g., 102a in FIG. 1) enters a first indication (at 314) that he or she is seeking a counterparty for a financial transaction involving a transfer of a first quantity of a fixed income asset or OTC derivative at a first proposed price. In a typical implementation, the first user may do this at user interface terminal 102a in a similar manner to within the interactions according to FIG. 3A.

In a typical implementation, the first party interface terminal sends (at 316) the first party's indications to the processing system 106 for processing. In response, the processing system 106 typically includes the specified quantity of the specified fixed income asset or OTC derivative in a pool of securities to be potentially transacted (i.e., transferred between parties) at a specified time. This pool may be stored in an electronic database, for example, in random access memory (RAM) module 120.

According to the illustrated method, a second party at a second user interface terminal (e.g., 102b in FIG. 1) enters (at 317) a second indication that the second party seeks a counterparty for a financial transaction involving a second quantity of the fixed income asset or OTC derivative at a second proposed price. In some embodiments, the second party further indicates the side of a transaction he or she wishes to take, that is, whether the second party is interested in buying or selling the entered quantity of the identified fixed income asset or OTC derivative.

In a typical implementation, the second user interface terminal 102b sends (at 317a) the second party's indication to the processing system 106 for processing. In response, the processing system 106 typically includes the quantity of the fixed income security or OTC derivative specified by the second party in a pool of securities to be potentially transacted at a specified time. This pool may be stored in an electronic database, for example, in random access memory (RAM) module 120.

In the embodiment shown, the fixed income asset or OTC derivative transaction is either a buying action or a selling action, and the first party's indication is for one of buying or selling and the second party's indication is for the other of buying or selling. In addition, in the embodiment shown, both the first party and the second party indicate that they are seeking a counterparty for a financial transaction involving the same fixed income asset or OTC derivative. As discussed herein, the first quantity specified by the first party and the second quantity specified by the second party can be the same or different quantities.

Assuming that the indications from the first party and the second party are both directed to the same fixed income asset or OTC derivative, the processing system 106 identifies the first party and the second party as candidate trading partners. The system then locks (318) the first party and the second party into a commitment to transfer ownership of either the first quantity or the second quantity of the fixed income asset or OTC derivative at a first sales price that is not revealed to the first party or the second party prior to locking into the commitment. As above, the time of the system lock (318) may be known to the first party and the second party in advance. In a typical implementation, for example, the processing system 106 may be configured to implement a new lock between parties that qualify as potential trading partners, for example, once a day or several times a day. System locks may be more or less frequent for more or less liquid securities. In general, after a lock occurs, any information that the parties enter into the system will not be used or considered by the system for the immediately upcoming transfers.

In general, after the processing system 106 system locks, the first party and the second party may no longer withdraw or edit their respective indications (i.e., either the first or second quantities or the identity of the corresponding fixed income asset or OTC derivative. Moreover, in general, the first and second parties become locked into the commitment by virtue of the processing system 106 initiating one or more steps that will result in the transfer of ownership without either the first party or the second party having the option of backing out of the commitment before the transfer has been completed.

After the system lock, the processing system 106 accesses (320) data that has been stored in memory (e.g., RAM module 120), as well as data from user indications. According to the illustrated method, the processing system 106 then calculates (e.g., with the computer-based processor 124) (at 322) a first sales price for the fixed income asset or OTC derivative. In a typical implementation, the first sales price is the price at which either the first quantity or the second quantity of the fixed income asset or OTC derivative will be transferred between the first party and the second party. Typically, the price is calculated sometime after the processing system 106 locks the parties into an agreement.

The first sales price can be calculated (i.e., the fixed income security or OTC can be valued) by using any one of a plurality of valuation techniques or algorithms leveraging at least some information submitted as part of the indication. Moreover, the first sales price can be calculated by the processing system 106 in FIG. 1 as described in relation to FIG. 3A. The first sales price provided to a first party and a second party may be different than the first sales price provided to different pairs of users. For example, the first party and the second party may receive one valuation (i.e., calculated per unit first sales price) whereas another matched pair of trading parties may receive a second, different valuation (i.e., calculated per unit first sales price) for the same fixed income asset or OTC derivative. In some instances, the difference in the calculated per unit first sales prices for the same fixed income asset or OTC derivative can be accounted for based, at least in part, on the fact that the proposed first sales prices submitted by the parties in each matched pair of trading partners differed from matched pair to matched pair.

In one example, all users on either side of the market are aggregated, and the valuation provided by the processing system (322) is an average of the aggregated values on the two sides of the market. In another example, users, or transactions, are paired based on some method which may be combined with some priority applied to the users, and the transaction value for each pairing is the average of the submitted values. This may be done, for example, by pairing the lowest bid with the highest offer, or the highest bid with the lowest offer, and the price may be the average of the bid and offer paired together. The average may be weighted, or may take place on quantity neutral basis. Similarly, security prices may be determined for individual securities and aggregated across quantities.

In various implementations, a value or valuation associated with the specified security is represented as a price, yield, or spread. The spread valuation represents, for example, the difference between the yield on two different investments. When evaluating a security in terms of spread, the second investment may be, for example, a credit risk-free benchmark security or a reference rate.

After the processing system 106 calculates the first sales price (e.g., provides a valuation for the security) (322), the processing system 106 generates an agreement to transact for all parties, including the first party and the second party, matched by the system (324). Such an agreement may be generated by applying the valuation provided to the commitment to transfer ownership generated when the system locks (318). When more than two parties submit orders, the illustrated embodiment matches orders based on price priority. In some implementations using aggregated averages, if an unequal quantity is identified on opposite sides of a transaction, the system matches the orders with the highest bids and the lowest offers first, and other submissions are more likely to be left with remainders after a cross. Alternatively, transactions may be matched based on size or time priority or some alternative selection process. The matching in the illustrated embodiment is anonymous.

Once the agreements to transact (324) are generated, the processing system 106 triggers a sequence of events that leads to the transfer of ownership of the first quantity or the second quantity of the fixed income asset or OTC derivative between the first party and the second party at the valuation. In some embodiments, the agreement to transact is submitted by the processing system 106 to a third party for clearing. In that example, the processing system 106 transmits electronic instructions to the third party at a third user interface terminal (e.g., 102e in FIG. 1) to clear the transaction (i.e., to transfer ownership of either the first quantity or the second quantity of the fixed income asset or OTC derivative between the first party and the second party at the first sales price). In other embodiments, processing system 106 may be configured to complete transactions and coordinate or complete the transfer of ownership of the fixed income asset or OTC derivative. The processing system may then calculate transaction fees (209) and report transactions resulting from the cross to participants (210), as well as complete any required third party reporting 211. For example, in some implementations, the processing system 106 transmits the clearing instructions to a third party at one of the user interface terminals (e.g., 102e).

FIG. 3C is a flowchart showing an exemplary interaction between users of the system and the computer-based processing system 106 of FIG. 1 to facilitate a transaction of a fixed income asset or OTC derivative. The exemplary interaction in FIG. 3C is similar to the exemplary implementation in FIG. 3A, except, in the exemplary interaction in FIG. 3C, a party approaches an order book containing live orders. When a party selects a fixed income security or OTC derivative in the order book, the party may be paired with a party who had previously placed the same security on the market and has agreed, explicitly or implicitly, to participate in the marketplace described. Where the interaction in FIG. 3A relies on a system lock for transactions, the interaction in FIG. 3C relies on orders resting on the marketplace so that crosses may occur as soon as a second party submits an indication that would like to transact in a fixed income security or OTC derivative that is on the market.

According to FIG. 3C, a second party accesses a list (at 326) and enters an indication that he or she seeks a counterparty for a financial transaction by selecting (at 328) a fixed income asset or OTC derivative from the list at a user interface terminal (e.g., 102b of FIG. 1). In another example, the second party may indicate a selection of a security by directly identifying it with a code, such as a CUSIP. The second party may further indicate a transaction quantity for a proposed transaction.

In a typical implementation, the second party accomplishes this by entering information into the user interface terminal 102b identifying a particular fixed income asset or OTC derivative he or she is interested in having transferred, identifying the first quantity (i.e., the amount of the fixed income asset or OTC derivative) he or she is interested in having transferred, as discussed above in reference to FIG. 3A.

In a typical implementation, the user interface interface terminal 102b sends (at 330), a request to the processing system 106 for processing. In a typical implementation, the request is to transact the selected security in the near future (e.g., as soon as possible after generating a valuation).

Once the indication is received at processing system 106, the processing system accesses (at 332) data that has been stored in memory (e.g., random access memory (RAM) module 120), including data that is related to one or more financial market observations. The data accessed can be used to calculate a first sales price (e.g., a valuation) for the fixed income asset or OTC derivative (334). In at least some implementations, the data does not include any information received in connection with the indication from the second party.

According to the illustrated method, the processing system 106 then calculates (e.g., with the computer-based processor 124) (at 334) a first sales price for the fixed income asset or OTC derivative. In a typical implementation, the first sales price is the price at which either the first quantity of the fixed income asset or OTC derivative will be transferred between the second party and a potential counterparty. The calculation of the first sales price may be based on, for example, the categories of data discussed in reference to FIG. A.

The first sales price can be calculated (i.e., the fixed income security or OTC can be valued) by using any one of a plurality of valuation techniques or algorithms. Moreover, the first sales price can be calculated by the processing system 106 in FIG. 1 or any other processor or computer-based processing system, or the data accessed by the processing system may be the first sales price itself. In some implementations, the valuation technique or algorithm may be applied in real time, and a projected value (i.e., the calculated first sales price) is a current value as of the time that the processing system accesses the data (332). Any valuation technique can be used as long as the price is unknown to the first party and the second party until after the time of the party's selection.

In one embodiment, for example, the processing system 106 calculates a first sales price by first accessing data that was previously stored in a database (e.g., in RAM module 120). This data can include, for example, data related to a plurality of financial market observations. The financial market observations may involve observations directly related to the specified securities, observations involving assets closely related to the specified security, or other observations, as discussed above in reference to FIG. 3A. In a typical implementation, the stored data will have been received from one or more of the data sources 108a, 108b . . . 108n and may have arrived at the processing system at different times.

After the processing system 106 provides a first sales price (334), the processing system determines if a potential transaction at the first sales price is acceptable to one or more of potentially multiple parties (336). This can include confirming that a first party that has previously indicated a willingness to transact in the selected security has agreed to transact at an unknown first sales price, and confirming that the first sales price is within parameters identified by the first party as acceptable. The first party indications related to willingness to transact in the selected security, willingness to transact at an unknown valuation, and parameters may be made explicitly by the first party at user interface terminal 102a, or some or all of the indications may be background options for an order book profile of the first user. The parameters indicated by the first party may be, for example, quantity thresholds, such as an “all or nothing” criteria applied to securities. Further, if transacting at the valuation is acceptable to more than two parties, the transaction may proceed with one or multiple counterparties on a time priority basis.

If the processing system 106 determines that the potential transaction is acceptable to multiple parties, the processing system 106 locks parties (e.g., a first party and a second party) into a commitment to transfer ownership of the fixed income security or OTC derivative, and applies the first sales price to the commitment (220) in order to generate an agreement to transact for the parties matched by the system (338). When more than two parties submit orders, the processing system 106 matches orders based on time priority. If an unequal quantity is identified on opposite sides of a transaction, processing system 106 matches the earliest orders to be submitted first, and later submissions are more likely to be left with remainders after a cross. Alternatively, transactions may be matched based on size priority or some alternative selection process. The matching in the illustrated embodiment is anonymous.

Once the agreements to transact (338) are generated, the processing system 106 triggers a sequence of events that leads to the transfer of ownership of the first quantity or the second quantity of the fixed income asset or OTC derivative between the first party and the second party at the valuation. In some embodiments, the agreement to transact is submitted by the processing system 106 to a third party for clearing. In that example, the processing system 106 transmits electronic instructions to the third party at a third user interface terminal (e.g., 102e in FIG. 1) to clear the transaction (i.e., to transfer ownership of either the first quantity or the second quantity of the fixed income asset or OTC derivative between the first party and the second party at the first sales price). In other embodiments, processing system 106 may be configured to complete transactions and coordinate or complete the transfer of ownership of the fixed income asset or OTC derivative. The processing system may then calculate transaction fees (209) and report transactions resulting from the cross to participants (210), as well as complete any required third party reporting 211. For example, in some implementations, the processing system 106 transmits the clearing instructions to a third party at one of the user interface terminals (e.g., 102e).

The exemplary interaction in FIG. 3D is similar to the exemplary implementation in FIG. 3C, except in the exemplary interaction in FIG. 3D, the second party enters a first proposed price for the fixed income asset or OTC derivative.

Moreover, in the exemplary interaction of FIG. 3D, the processing system 106 generally takes these proposed prices into consideration in calculating the first sales price for the quantity of the fixed income asset or OTC derivative to be transferred.

FIG. 3D is a flowchart showing an exemplary interaction between users of the system and the computer-based processing system 106 of FIG. 1 to facilitate a transaction of a fixed income asset or OTC derivative. According to FIG. 3D, a second party accesses a list (at 340) and enters an indication that he or she seeks a counterparty for a financial transaction by selecting (at 342) a fixed income asset or OTC derivative from the list at a user interface terminal (e.g., 102b of FIG. 1). In another example, the second party may indicate a selection of a security by directly identifying it with a code such as a CUSIP. The second party may further indicate a transaction quantity for a proposed transaction, as well as a proposed valuation.

In a typical implementation, the second party accomplishes this by entering information into the user interface terminal 102b identifying a particular fixed income asset or OTC derivative he or she is interested in having transferred, identifying the first quantity (i.e., the amount of the fixed income asset or OTC derivative) he or she is interested in having transferred, as discussed above in reference to FIG. 3A.

In a typical implementation, the second party interface terminal 102b sends (at 344) a request to the processing system 106 for processing. In a typical implementation, the request is to transact the selected security in the near future (e.g., as soon as possible after generating a valuation).

Once the indication is received at the processing system 106, the processing system accesses (346) data that has been stored in memory (e.g., random access memory (RAM) module 120), as well as data submitted with the second party's indication and data related to pending indications of willingness to transact previously provided by, for example, a first party among other potential counterparties. The processing system 106 uses the data that has been stored in memory to identify a first potential counterparty (348).

Once a potential counterparty is identified (348) the processing system 106 uses the data submitted with the second party's indication (at 342), as well as the data related to the first potential counterparty, to provide a first sales price for the security (350). The processing system 106 then determines if the potential transaction is acceptable to the multiple parties involved (352). This can include confirming that the first potential counterparty is willing to transact in the selected security, has agreed to transact at an unknown first sales price, and confirming that the first sales price is within the parameters identified by the first potential counterparty as acceptable.

If the potential transaction is acceptable, the processing system 106 locks the second user and the first potential counterparty into a commitment to transfer ownership of the security (207), and assigns a value to the commitment (220) in order to generate an agreement to transact between the matched parties (354). If, however, the potential transaction is unacceptable to one of the parties, the processing system 106 attempts to identify an additional potential counterparty (348) and continues to evaluate by providing a first sales price (350) and assessing the acceptability of a proposed transaction (352). If multiple parties may be identified as potential counterparties, the system matches parties based on price priority. In alternative embodiments, parties may be matched on time priority, or based on some other algorithm.

Once the agreements to transact (354) are generated, the processing system 106 triggers a sequence of events that leads to the transfer of ownership of the first quantity or the second quantity of the fixed income asset or OTC derivative between the first party and the second party at the valuation. In some embodiments, the agreement to transact is submitted by the processing system 106 to a third party for clearing. In that example, the processing system 106 transmits electronic instructions to the third party at a third user interface terminal (e.g., 102e in FIG. 1) to clear the transaction (i.e., to transfer ownership of either the first quantity or the second quantity of the fixed income asset or OTC derivative between the first party and the second party at the first sales price). In other embodiments, processing system 106 may be configured to complete transactions and coordinate or complete the transfer of ownership of the fixed income asset or OTC derivative. The processing system may then calculate transaction fees (209) and report transactions resulting from the cross to participants (210), as well as complete any required third party reporting 211. For example, in some implementations, the processing system 106 transmits the clearing instructions to a third party at one of the user interface terminals (e.g., 102e).

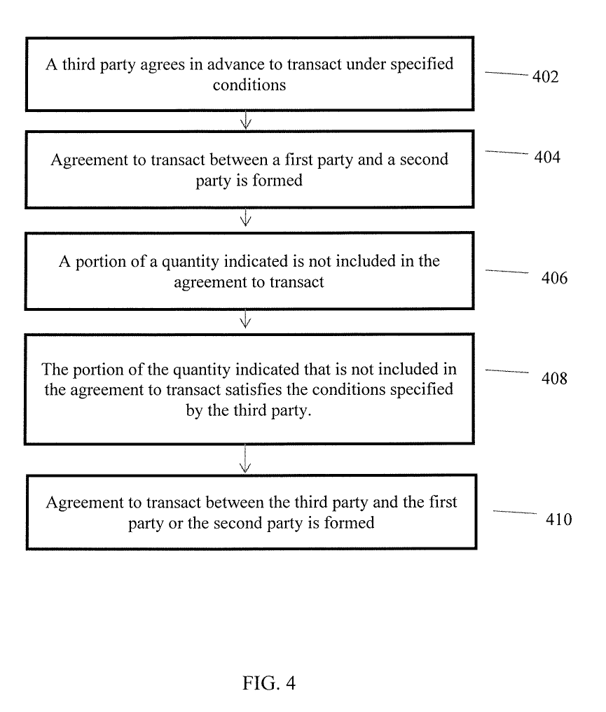

FIG. 4 is a flowchart that represents a user's interactions with a third party liquidity provider using the computer system of FIG. 1 in an exemplary embodiment. In the various embodiments of FIGS. 3A-3D, any party utilizing processing system 106 to conduct a trade may be left with a remainder. This may be, for example, due to a first user and a second user seeking to transact in different quantities, or due to a pooled group of transactions having more assets on one side of a market than on the other. In the illustrated embodiment, a third party enters a third indication from a third computer-based user interface terminal (e.g., 102c) that they are willing to obtain or sell a remainder portion, if any exists, from ownership transfers that occur between other parties (e.g., a first party and a second party). When the first party or the second party has a remainder, the processing system 106 locks the third party into a commitment to transfer ownership with the party having the remainder for the remainder portion of the fixed income asset or the OTC derivative. In some embodiments, the commitment is to pay the first sales price or a second sales price that is not revealed to the first party, the second party, or the third party prior to locking the parties into the commitment. Similarly, when the first party or the second party has not had an order filled, the processing system 106 locks the third party into a commitment to transfer ownership with the party that has not had their order filled. The commitment to transfer ownership is for the third party to transfer ownership to the first or second party seeking to fill an order at the first sales price or at a second sales price that is not revealed to the first party, the second party, or the third party prior to locking the parties into the commitment.

In some embodiments, the party having the remainder portion may have an option to retain ownership independent of the third party being willing to obtain the remainder portion. In other embodiments, the party having the remainder portion may have an option to request via a user interface terminal 102a and processing system 106 one or more quotations for the remainder portion from potential counterparties.

In the illustrated embodiment, the third party has agreed in advance to transact for the remainder under specified conditions (402). In a preferred embodiment, the specified condition is that the price or quantity falls within a specified range which can be determined algorithmically. In some embodiments, the specified condition is that the third party finds the transaction acceptable on a case by case basis, creating a right of first refusal for the third party.

In the illustrated embodiment, the processor forms an agreement to transact between a first party and a second party (404). The agreement can be formed by utilizing the methods of FIGS. 3A-3D implemented in connection with the processing system 106. When the agreement is formed (404) and/or the transfer is complete, one party is left with a remainder constituting a portion of a quantity indicated by the party that is not included in the agreement to transact (406). The processing system 106 then compares the portion of the quantity indicated that is not included in the agreement between the first party and the second party to the conditions specified by the third party (408). In some embodiments, the comparison is to determine if the valuation used in a transaction falls within acceptable bounds. In other embodiments, the processing system 106 presents at a user interface terminal 102c for the third party a message indicating that the third party has the right of first refusal, and presents the third party with an option to accept or reject the potential transaction. If the remainder portion satisfies the conditions specified by the third party, an agreement to transact is formed between the third party and whichever of the first and second parties hold a remainder (410).

In some embodiments, when a portion of a quantity indicated is not included in the initial agreement to transact (406), the party having the remainder is presented with an option 218 to transact with liquidity partners. Should the party select that option, their order will be compared to the criteria of the third party liquidity provider.

A number of embodiments of the invention have been described. Nevertheless, it will be understood that various modifications may be made without departing from the spirit and scope of the invention.

For example, embodiments of the subject matter and the operations described in this specification can be implemented in digital electronic circuitry, or in computer software, firmware, or hardware, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The terms “computer system,” “computer-based system” or “computer-based method” encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer (e.g., a user interface terminal) having a display device, e.g., a CRT (cathode ray tube), LCD (liquid crystal display) monitor or touchscreen, for displaying information to the user and/or a keyboard and/or a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be indicated in the numbered paragraphs near the end of this disclosure, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described in the numbered paragraphs near the end of this disclosure as such, one or more features from such a combination can in some cases be excised from the combination, and the combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

Other implementations are within the scope of the claims.

1. A computer-based method comprising:
receiving a first indication from a first computer-based user interface terminal that a first party seeks a counterparty for a financial transaction involving a transfer of a first quantity of a fixed income asset or over-the-counter (OTC) derivative;
receiving a second indication from a second computer-based user interface terminal that a second party seeks a counterparty for a financial transaction involving a transfer of a second quantity of the fixed income asset or OTC derivative; and
locking the first party and the second party into a commitment to transfer ownership of the first quantity or the second quantity of the fixed income asset or OTC derivative at a first sales price that is not revealed to the first party or the second party prior to locking into the commitment.

2. The computer-based method of claim 1 further comprising:
calculating, with a computer-based processor, the first sales price for the fixed income asset or OTC derivative.

3. The computer-based method of claim 2 wherein the first sales price for the fixed income asset or OTC derivative is calculated after receiving the first indication and the second indication.

4. The computer-based method of claim 2, wherein the first sales price is calculated based on information stored in a computer-based memory storage that does not include any information received in connection with the first indication or the second indication.

5. The computer-based method of claim 2, wherein the first sales price is calculated as either a midpoint or an approximate midpoint between a first proposed price received in connection with the first indication and a second proposed price received in connection with the second indication.

6. The computer-based method of claim 2, wherein the first sales price is calculated at a random point during a predefined window of time that begins when the first party and the second party become locked into the commitment.

7. The computer-based method of claim 1, further comprising:
after locking the first party and the second party into the commitment, triggering a sequence of events that leads to the transfer of ownership of the first quantity or the second quantity of the fixed income asset or OTC derivative between the first party and the second party at the first sales price.

8. The computer-based method of claim 1, wherein locking the first party and the second party into the commitment occurs at a predetermined crossing time, as determined by a computer-based timer, after receiving the first indication and the second indication.

9. The computer-based method of claim 1, wherein locking the first party and the second party into the commitment occurs after receiving the latter of the first indication and the second indication, without waiting for a predetermined crossing time.

10. The computer-based method of claim 1, wherein the first quantity of the fixed income asset or OTC derivative is different than the second quantity of the fixed income asset or OTC derivative such that, after locking the first party and the second party into the commitment, the transfer of ownership leaves a remainder portion with either the first party or the second party that is not transferred as part of the transfer of ownership.

11. The computer-based method of claim 10, further comprising:
receiving a third indication from a third computer-based user interface terminal that a third party seeks to obtain a remainder portion, if any, from ownership transfers that occur between any parties involving the fixed income asset or OTC derivative; and
locking the third party and the first party or the second party into a commitment to transfer ownership of the remainder portion of the fixed income asset or OTC derivative at the first sales price or at a second sales price that is not revealed to the first party, the second party or the third party prior to locking the third party and the first party or the second party into the commitment.

12. The computer-based method of claim 1, further comprising:
receiving an indication from a fourth computer-based interface terminal that a fourth party is willing to sell a quantity of the fixed income security or OTC derivative to any party whose request is not satisfied by a transaction; and
locking the fourth party and the first party or the second party into a commitment to transfer ownership of the quantity of the fixed income security or OTC derivative to satisfy a portion of the first or second party's request that is not satisfied by the transaction between the first party and the second party,
wherein the transfer of ownership from the fourth party to the first party or the second party occurs at a second sales price that is not revealed to the first party, the second party or the fourth party prior to locking the fourth party and the first party or the second party into the commitment.

13. A computer system comprising:
a first computer-based user interface terminal;
a second computer-based user interface terminal; and
a computer-based crossing engine coupled to the first and second computer-based user interface terminals over a computer network, wherein the computer-based crossing engine comprises a computer-based processor and a computer-based memory storage and is configured to:
receive a first indication from the first computer-based user interface terminal that a first party seeks a counterparty for a financial transaction involving a transfer of a first quantity of a fixed income asset or over-the-counter (OTC) derivative;
receive a second indication from the second computer-based user interface terminal that a second party seeks a counterparty for a financial transaction involving a transfer of a second quantity of the fixed income asset or OTC derivative; and
lock the first party and the second party into a commitment to transfer ownership of the first quantity or the second quantity of the fixed income asset or OTC derivative at a sales price that is not revealed to the first party or the second party prior to locking into the commitment.

14. The computer system of claim 13 wherein the computer-based crossing engine is further configured to:
calculate, with the computer-based processor, the sales price for the fixed income asset or OTC derivative.

15. The computer system of claim 14 wherein the sales price for the fixed income asset or OTC derivative is calculated after the computer-based crossing engine receives the first indication and the second indication.

16. The computer system of claim 14, wherein the sales price is calculated based on information stored in a computer-based memory storage that does not include any information received in connection with the first indication or the second indication.

17. The computer system of claim 13, wherein the sales price is calculated as either a midpoint or an approximate midpoint between a first proposed price received in connection with the first indication and a second proposed price received in connection with the second indication.

18. The computer system of claim 13, wherein the sales price is calculated at a random point during a predefined window of time that begins when the first party and the second party become locked into the commitment.

19. The computer system of claim 13, wherein the computer-based crossing engine is further configured to:
after locking the first party and the second party into the commitment, trigger a sequence of events that leads to the transfer of ownership of the first quantity or the second quantity of the fixed income asset or OTC derivative between the first party and the second party at the sales price.

20. The computer system of claim 13, wherein the computer-based crossing engine further comprises a computer-based timer, and
wherein locking the first party and the second party into the commitment occurs at a predetermined crossing time, as determined based on the computer-based timer, after receiving the first indication and the second indication.

21. The computer system of claim 13, wherein locking the first party and the second party into the commitment occurs after receiving the latter of the first indication and the second indication, without waiting for a predetermined crossing time.

22. A non-transitory, computer-readable medium that stores instructions executable by a processor to perform the steps comprising:
receiving a first indication from a first computer-based user interface terminal that a first party seeks a counterparty for a financial transaction involving a transfer of a first quantity of a fixed income asset or over-the-counter (OTC) derivative;
receiving a second indication from a second computer-based user interface terminal that a second party seeks a counterparty for a financial transaction involving a transfer of a second quantity of the fixed income asset or OTC derivative; and
locking the first party and the second party into a commitment to transfer ownership of the first quantity or the second quantity of the fixed income asset or OTC derivative at a sales price that is not revealed to the first party or the second party prior to locking into the commitment.

23. The non-transitory, computer-readable medium of claim 22 storing further instructions executable by the processor to perform the step comprising:
calculating the sales price for the fixed income asset or OTC derivative.

24. The non-transitory, computer-readable medium of claim 23, wherein the sales price for the fixed income asset or OTC derivative is calculated after receiving the first indication and the second indication.

25. The non-transitory, computer-readable medium of claim 23, wherein the sales price is calculated based on information stored in a computer-based memory storage that does not include any information received in connection with the first indication or the second indication.

26. The non-transitory, computer-readable medium of claim 23, wherein the sales price is calculated as either a midpoint or an approximate midpoint between a first proposed price received in connection with the first indication and a second proposed price received in connection with the second indication.

27. The non-transitory, computer-readable medium of claim 23, wherein the sales price is calculated at a random point during a predefined window of time that begins when the first party and the second party become locked into the commitment.

28. The non-transitory, computer-readable medium of claim 23, storing further instructions executable by the processor to perform the step comprising:
after locking the first party and the second party into the commitment, triggering a sequence of events that leads to the transfer of ownership of the first quantity or the second quantity of the fixed income asset or OTC derivative between the first party and the second party at the sales price.

29. The non-transitory, computer-readable medium of claim 23, wherein locking the first party and the second party into the commitment occurs at a predetermined crossing time, as determined by a computer-based timer, after receiving the first indication and the second indication.

30. The non-transitory, computer-readable medium of claim 23, wherein locking the first party and the second party into the commitment occurs after receiving the latter of the first indication and the second indication, without waiting for a predetermined crossing time.
